(19) United States
(12) Patent Application Publication
(10) Pub. No.: US 2012/0057911 A1
(43) Pub. Date: Mar. 8, 2012

(54) Heating roller comprising induction heating coil made of nickel alloy, fixing unit and image forming apparatus having the same

(75) Inventor: Sok-won Paik, Jeonju-si (KR)

(73) Assignee: SUMSUNG ELECTRONICS CO., LTD., Suwon (KR)

(21) Appl. No.: 13/064,228

(22) Filed: Mar. 11, 2011

(30) Foreign Application Priority Data
Sep. 2, 2010 (KR) 10-2010-0086118

(51) Int. Cl. G03G 15/20

(52) U.S. Cl. 399/333

(57) ABSTRACT

A heating roller is provided in an image forming apparatus and includes a roller body and an induction heating layer surrounding the roller body to generate Joule's heat by an induction current. The induction heating layer is made of an induction heating coil wound around the surface of the roller body and the induction heating coil is made of a nickel alloy.

### CROSS-REFERENCE TO RELATED APPLICATIONS

This application claims priority from Korean Patent Application No. 2010-0086118, filed on Sep. 2, 2010, in the Korean Intellectual Property Office, the disclosure of which is incorporated herein by reference in its entirety.

### BACKGROUND

1. Field

Aspects relate to a heating roller and a fixing unit and an image forming apparatus having the same, and more particularly, to a heating roller having an induction heating coil made of nickel alloy and a fixing unit and an image forming apparatus having the same.

2. Description of the Related Art

An image forming apparatus employing electrophotographic image forming technology, such as a printer, a copy machine, a facsimile machine, and the like, generally includes a fixing unit to fix developer (e.g., a toner), transferred on a printing medium. The fixing unit includes a pressure roller pressing a printing medium and a heating roller applying heat to the printing medium, which are disposed to face each other and the printing medium passes therethrough.

The heating roller includes a heating device. There are several types of heating devices: a type directly connected to a power supply to generate Joule's heat such as a halogen lamp; and a type not directly connected to a power supply but generating Joule's heat by current flowing therethrough by electromagnetic induction. Hereinafter, a heating device generating Joule's heat by electromagnetic induction is referred to as an ‘induction heating layer’ and a heating roller including the induction heating layer is referred to as an ‘induction heating roller’.

A nickel belt is often used as the induction heating layer of the induction heating roller. In general, the nickel belt is cylindrical and is mounted to a roller body such that the roller body coated with adhesive is inserted into the nickel belt.

The nickel belt may be manufactured by electroplating, drawing, or extrusion. These manufacturing methods take a long time so manufacturing costs of the nickel belt are relatively high.

Since the nickel belt is relatively thin, the nickel belt may crack during the manufacturing or the use thereof.

Moreover, since adhesive leaks out by the nickel belt when the nickel belt is attached to the roller body with adhesive, it is not easy to attach the nickel belt to the roller body. Thus, the nickel belt may move relative to the roller body.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiment provide a heating roller in which manufacturing time and costs of an induction heating layer are reduced, which the induction heating layer is prevented from cracking, and which the induction heating layer is prevented from moving against a roller body, and a fixing unit and an image forming apparatus including the heating roller.

According to an aspect of an exemplary embodiment, there is provided a heating roller provided in a fixing unit of an image forming apparatus, the heating roller including: a roller body; and an induction heating layer surrounding the roller body and generating Joule's heat by an induction current; wherein the induction heating is made of an induction heating coil wound around the surface of the roller body and the induction heating coil is made of a nickel alloy. According to an aspect of an exemplary embodiment, there is provided a fixing unit and an image forming apparatus including the heating roller.

The induction heating coil may be made of a nickel-iron alloy.

In the nickel-steel alloy, content of nickel may be 36 weight (wt) %.

The induction heating coil may be coated with copper or aluminum.

The heating roller may include a coil insertion recess that is disposed along a path in which the induction heating coil is wound around the roller body, and at least a part of the induction heating coil is inserted into the coil insertion recess.

A portion of the induction heating coil that is wound around a region of the heating roller having relatively high temperature-increase characteristics may have a relatively low winding density

A portion of the induction heating coil that is wound around a region of the heating roller having relatively high temperature-increase characteristics may be wound by the relatively small number of layers

A portion of the induction heating coil that is wound around a region of the heating roller having relatively high temperature-increase characteristics may have a relatively low magnetic permeability.

The heating roller may further include a first elastic layer disposed between the roller body and the induction heating coil and an adhesive layer disposed on the first elastic layer for bonding of the induction heating coil.

The heating roller may further include a second elastic layer disposed on the induction heating layer and a release layer disposed on the second elastic layer to prevent a printing medium from sticking to the heating roller.

The roller body may be made of ceramic.

The roller body may be made of aluminum.

The heating roller may further include an insulating layer disposed between the roller body and the induction heating coil.

The roller body may be a hollow cylinder.

Additional aspects and advantages of the exemplary embodiments will be set forth in the detailed description, will be apparent from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a perspective view illustrating a heating roller according to an exemplary embodiment;

FIG. 2 is a front view of the heating roller in FIG. 1;

FIG. 3 is an enlarged sectional view of the heating roller taken along the line III-III of FIG. 2;

FIG. 4 is a partial enlarged sectional view of the heating roller taken along the line IV-IV in FIG. 3;

FIG. 5 is a perspective view of the heating roller in FIG. 1 while omitting a second elastic layer and a release layer such that an induction heating coil appears;

FIG. 6 is a partial sectional view illustrating a heating roller according to another exemplary embodiment;

FIG. 7 is a perspective view illustrating a heating roller according to still another exemplary embodiment;

FIG. 8 is a graph illustrating comparison of temperature-increase characteristics of the heating roller according to an exemplary embodiment to an existing heating roller; and

FIG. 9 is a schematic view illustrating an image forming apparatus according to an exemplary embodiment.

### DETAILED DESCRIPTION

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

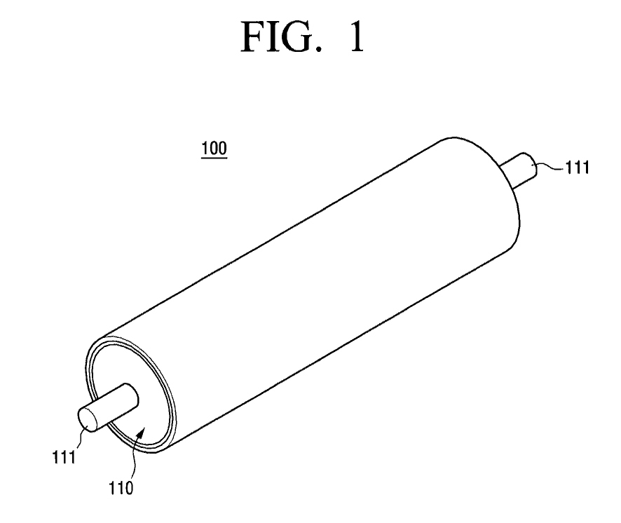

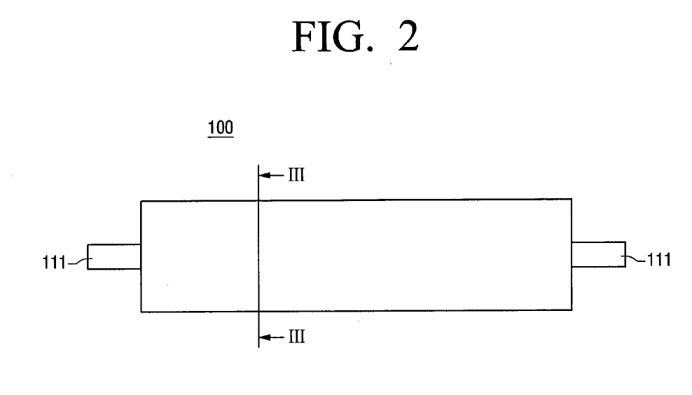

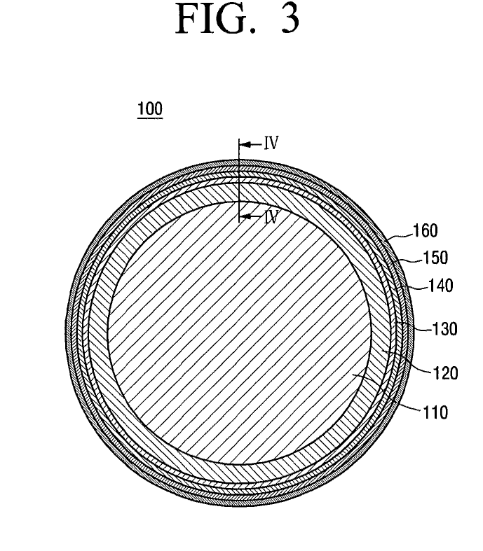

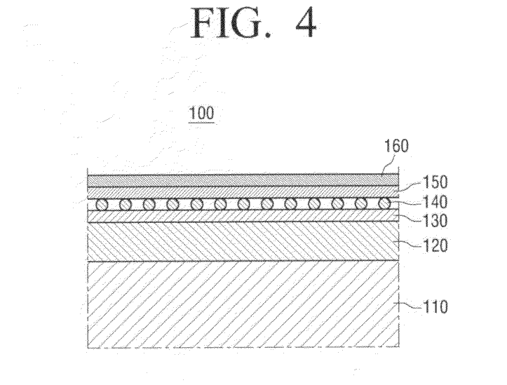

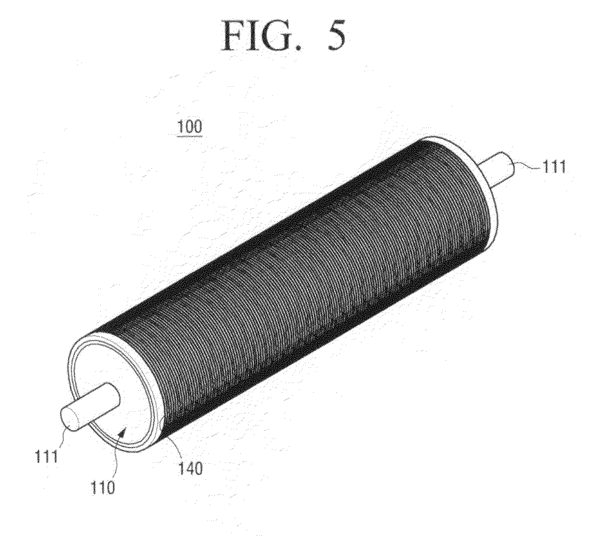

A heating roller 100 according to an exemplary embodiment of the present invention will be described with reference to FIGS. 1 to 5. FIG. 1 is a perspective view illustrating a heating roller 100 according to an exemplary embodiment. FIG. 2 is a front view of the heating roller 100 in FIG. 1. FIG. 3 is an enlarged sectional view of the heating roller 100 taken along the line III-III of FIG. 2. FIG. 4 is a partial enlarged sectional view of the heating roller 100 taken along the line IV-IV in FIG. 3. FIG. 5 is a perspective view of the heating roller 100 in FIG. 1 while a second elastic layer 150 and a release layer 160 are omitted such that an induction heating coil 140 appears.

Referring to FIGS. 1 to 5, the heating roller 100 according to an embodiment includes a roller body 110, a first elastic layer 120, an adhesive layer 130, an induction heating layer (induction heating coil) 140, a second elastic layer 150, and a release layer 160.

The roller body 110 is cylindrical. In another exemplary embodiment, the roller body 110 may be a hollow pipe. A pair of shaft members 111 is provided to ends of the roller body 110. A rotating power of a driving device such as a motor (not shown) is transmitted to the roller body 110 through the shaft members 111 so that the roller body 110 may rotate about a rotation axis of the shaft members 111.

The roller body 110 may be made of a nonconductor or a non-magnetic metal. The nonconductor applicable to the roller body 110 may be ceramic and the non-magnetic metal applicable to the roller body 110 may be aluminum and SUS 300. When the roller body 110 is made of a nonconductor, the roller body 110 is prevented from being unintentionally heated by being conducted with the induction heating layer 140. When the roller body 10 is made of non-magnetic metal, the roller body 110 is prevented from generating undesired induction current. In this exemplary embodiment, the roller body 110 is made of nonconductive ceramic.

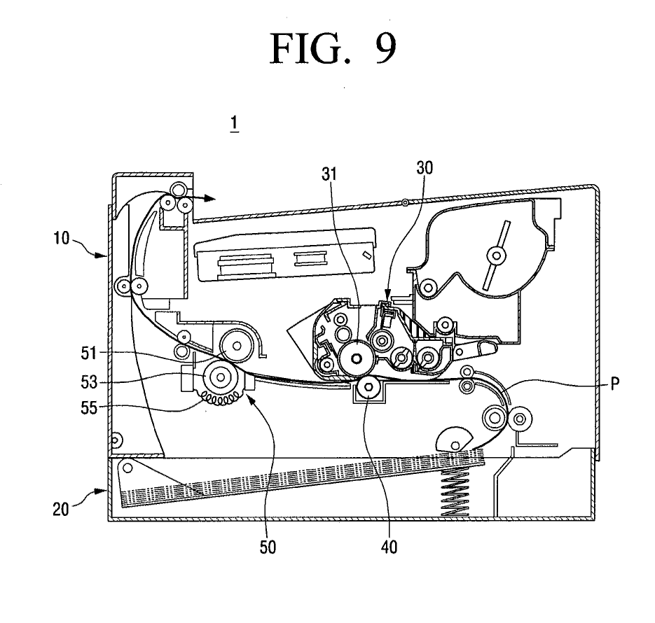

The first elastic layer 120 is disposed between the roller body 110 and the adhesive layer 130 to surround the roller body 110. The first elastic layer 120 is made of elastic material such as sponge, rubber, and the like. The first elastic layer 120 may form a sufficient size of a nip between the heating roller 100 and a pressure roller (for example, a reference numeral ‘51’ in FIG. 9) disposed to face the heating roller 100. The first elastic layer 120 servers to prevent current and heat that are generated from the induction heating layer 140 from being transmitted to the roller body 110. That is, the first elastic layer 120 serves as an isolator of electric current and heat against the roller body 110.

The adhesive layer 130 is coated on the first elastic layer 120. The induction heating layer 140 may be bonded to the first elastic layer 120 by the adhesive layer 130 so that the induction heating layer 140 may be prevented from being moved along the rotation axis of the roller body 110.

The induction heating layer (induction heating coil) 140 is made of a coil wound around the roller body 110. More specifically, the induction heating coil 140 surrounds the first elastic layer 120 around the roller body 110.

Since the induction heating coil 140 is made in the form of a coil (or a wire), manufacturing time and costs are reduced, in comparison to an existing induction heating layer made in the form of a belt, and possibility of generating crack may be also reduced. Since the induction heating coil 140 is mounted on the roller body 110 by winding the roller body 110, the induction heating coil 140 may be secured to the roller body 110 with adhesive. Thus, possibility of the induction heating coil 140 moving along the rotation axis of the roller body 110 may be reduced.

The induction heating coil 140 is made of magnetic metal. Thus, when current flows an exciting coil (for example, a reference numeral 55 in FIG. 9) close to the heating roller 100, induction current flows the induction heating coil 140 according to an electromagnetic induction principle. When induction current flows the induction heating coil 140, the induction heating coil 140 may generate Joule's heat required to fix a developer.

In this exemplary embodiment, the induction heating coil 140 is made of a nickel alloy which is a kind of magnetic substance. More specifically, the induction heating coil 140 is made of a nickel-iron alloy. The induction heating coil 140 may be coated with copper or aluminum in order to enhance exothermic property.

Here, the nickel-steel alloy used in manufacturing the induction heating coil 140 may be a nickel-iron alloy in which content of nickel is 36 wt %, sold under the trademark name INVAR.

The first reason is because the thermal expansion coefficient of the INVAR is substantially zero. Thus, the induction heating coil 140 made of INVAR is rarely thermal-deformed. Although temperature of the induction heating coil 140 varies, the induction heating coil 140 is hardly separated from the adhesive layer 130. Thus, the induction heating coil 140 hardly moves along the rotation axis of the roller body 110 due to the thermal deformation.

The second reason is because the Currie temperature of INVAR is about 277 degrees Celsius. For the reference, Currie temperature means temperature that magnetic property is lost when the temperature of the material increases. Thus, since the induction heating coil 140 made of INVAR loses magnetic property at a temperature higher than 277 degrees Celsius, the induction heating coil 140 generates the induction current no longer.

Since Currie temperature of INVAR is about 277 degrees Celsius, temperature of the induction heating coil 140 made of INVAR may be increased to about 277 degrees Celsius when heating. In general, surface temperature of the heating roller 100 required to fix developer is higher than 200 degrees Celsius. Considering temperature drop between the surface of the heating roller 100 and the induction heating coil 140, the induction heating coil 140 must be heated higher than about 250 degrees Celsius when the developer is fixed. In this exemplary embodiment, since temperature of the induction heating coil 140 may be increased to about 277 degrees Celsius when heating, the surface of the heating roller 100 may be heated to sufficient temperature for fixing.

The induction heating layer 140 must not be overheated. If overheated, printing quality may be degraded or fire may break out. Considering these, since the induction heating layer 140 made of INVAR loses its magnetic property and generates heat no longer at a temperature higher than 277 degrees Celsius, it may be considered that INVAR provides an overheating prevention property to the induction heating layer 140.

The overheating prevention property of the induction heating coil 140 is particularly important when a small size (narrow width) of a printing medium is fixed. When fixing a small size of a printing medium, a central region of the heating roller 100 comes in contact with the printing medium while edge regions thereof does not come in contact with the printing medium. In this case, the central region of the heating roller 100 loses heat to the printing medium but the edge regions thereof does not substantially lose heat to the printing medium. Thus, the edge regions of the heating roller 100 may be overheated. However, since the induction heating layer 140 is made of INVAR, the induction heating layer 140 in the edge regions immediately loses magnetic property and generates heat no longer when the edge regions of the heating roller 100 is heated higher than 277 degrees Celsius. Consequently, overheat of the heating roller 100 that may occur when a small size of a printing medium is fixed may be prevented.

The second elastic layer 150 is disposed between the induction heating coil 140 and the release layer 160 to surround the induction heating coil 140. The second elastic layer 150 may be made of elastic liquid silicon rubber (LSR). The second elastic layer 150 may transmit heat from the heating roller 100 to overall printing medium uniformly, so that glossiness of an image printed on the printing medium may be improved. The second elastic layer 150 has thermal capacity higher than the induction heating layer 140. Thus, when heat is transferred to the printing medium through the second elastic layer 150, in comparison to direct heat transfer from the induction heating coil 140 to the printing medium without the second elastic layer 150, fixing temperature of the printing medium may be maintained uniform. Thus, the fixing property of the heating roller 100 may be enhanced by the second elastic layer 150.

The release layer 160 is disposed to surround the second elastic layer 150. The release layer 160 is made of a material having a different polarity from the developer, for example, polytetrafluoroethylene (PTEE) or perfluoroalkoxy (PFA). The release layer 160 may prevent developer from sticking to the surface of the heating roller 100.

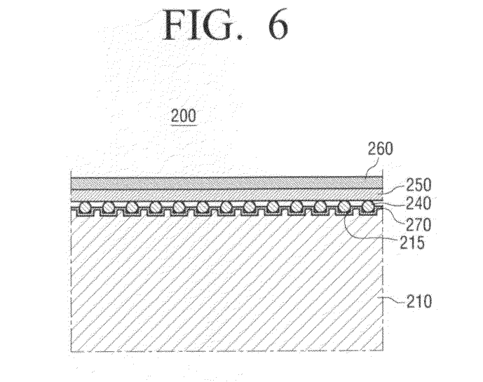

A heating roller 200 according to another exemplary embodiment will be described with reference to FIG. 6. FIG. 6 is a partial sectional view of the heating roller 200 according to another exemplary embodiment and similar to FIG. 4.

Referring to FIG. 6, the heating roller 200 according to another exemplary embodiment includes a roller body 210, an insulating layer 270, an induction heating layer (induction heating coil) 240, an elastic layer 250, and a release layer 260. Here, since the induction heating coil 240, the elastic layer 250, and the release layer 260 are substantially identical to the induction heating coil 140, the second elastic layer 150, and the release layer 160 of the heating roller 100 according to the above-described exemplary embodiment, description for the elements 240, 250, and 260 will be omitted.

A coil insertion recess 215 is formed on the surface of the roller body 210. The coil insertion recess 215 is formed on the surface of the roller body 210 along the path around which the induction heating coil 240 is wound. The induction heating coil 240 is inserted into the coil insertion recess 215 partially when the induction heating coil 240 is wound around the roller body 210. In another exemplary embodiment, the induction heating coil 240 may be inserted into the coil insertion recess 215 totally. As such, the induction heating coil 240 is inserted into the coil insertion recess 215 so that the induction heating coil 240 may be prevented from moving along the rotation axis of the roller body 210. Thus, in this exemplary embodiment, the adhesive layer bonding the induction heating coil 240 may be omitted.

The roller body 210, although not limited to these materials, may be made of metal such that the coil insertion recess 215 is easily formed. For example, the roller body 210 may be made of aluminum or SUS 300. In this exemplary embodiment, the roller body 210 is made of aluminum.

The roller body 210 has an insulating layer 270 formed on the surface. The insulating layer 270 may prevent the induction heating coil 240 made of metal and the roller body 210 made of metal from being conducted with each other. The insulating layer 270 may be aluminum oxide generated by oxidizing the aluminum roller body 210.

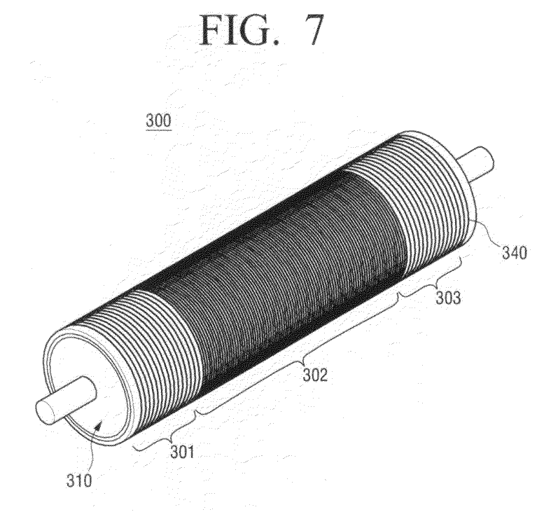

A heating roller 300 according to still another exemplary embodiment will be described with reference to FIG. 7. FIG. 7 is a perspective view illustrating the heating roller 300 according to still another exemplary embodiment and similar to FIG. 5. For the purpose of description, it should be noticed that an elastic layer and a release layer of the heating roller 300 are omitted from FIG. 7.

Referring to FIG. 7, the heating roller 300 according to still another exemplary embodiment includes a roller body 310 and an induction heating layer (induction heating coil) 340.

Axial temperature on the surface of the heating roller 300 may be distributed nonuniformly due to several factors such as ambient airflow characteristics, and etc. That is, although the induction heating coil 340 generates heat along the rotation axis of the heating roller 300 uniformly, the temperature-increase characteristic of the surface of the heating roller 300 may be nonuniform along the axial direction. However, it is desirable that the axial temperature distribution of the surface of the heating roller 300 is uniform.

FIG. 7 shows a case where edge regions 301 and 303 of the heating roller 300 have temperature-increase characteristics higher than a central region 302. That is, temperature of the edge regions 301 and 303 of the heating roller 300 may increase higher than the central region 302 when same heat is applied. Thus, the induction heating coil 340 is wound such that the edge regions 301 and 303 of high temperature-increase characteristics are wound with relatively low winding density and the central region 302 of low temperature-increase characteristics is wound with relatively high winding density. As such, since the winding density of the induction heating coil 340 varies along the axial direction of the heating roller 300 so that the axial temperature distribution of the surface of the heating roller 300 may be uniform.

On the contrary to FIG. 7, when the central region 302 of the heating roller 300 has higher temperature-increase characteristics than the edge regions 301 and 302, the central region 302 of the induction heating coil 340 may be wound with relatively low winding density. In addition, the temperature-increase characteristics of the heating roller 300 may continuously vary along the axial direction. In this case, the induction heating coil 340 may be wound around the roller body 310 with winding density which varies continuously in a manner that the stronger the temperature-increase characteristics in a region are, the lower the winding density becomes.

In alternative exemplary embodiment, the induction heating coil 340 may have the number of layers wound along the axial direction. In the case of FIG. 7, the induction heating coil 340 may be wound in a single layer around the edge regions 301 and 303 of high temperature-increase characteristics and in double layers around the central region 302 of low temperature-increase characteristics.

In alternative exemplary embodiments, magnetic permeability of the induction heating coil 340 may vary along the axial direction of the heating roller 300. For example, in the case of FIG. 7, the induction heating coil 340 may have relatively low magnetic permeability at the edge regions 301 and 303 of high temperature-increase characteristics and have relatively high magnetic permeability at the central region 302 of low temperature-increase characteristics. As the higher the magnetic permeability is, the higher the heat generation is, the heat generation of the edge regions 301 and 303 becomes lower than the central region 302. Thus, the axial temperature distribution of the surface of the heating roller 300 may be uniform.

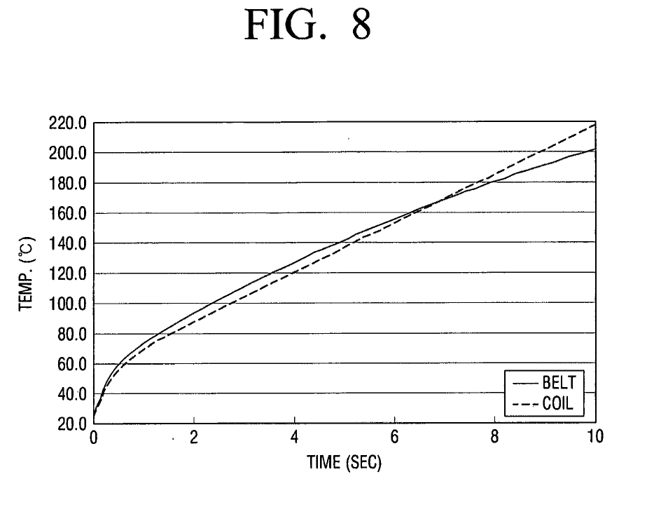

Simulation has been carried out to compare the heating roller using the induction heating coil that is made of INVAR according to the embodiments with a prior art heating roller using the nickel belt as an induction heating coil, and the results of the simulation are illustrated by a graph in FIG. 8. In the simulation, the heating roller 100 according to the embodiments is used as the heating roller and the existing heating roller is substantially identical to the heating roller 100 according to the embodiments except that the induction heating layer is the nickel belt.

FIG. 8 is a graph illustrating the comparison of temperature-increase characteristics of the heating roller according to the embodiments to the prior art heating roller. In the graph, a solid line indicates results of the simulation carried out with the prior art heating roller and a dotted line indicates results of the simulation carried out with the heating roller according to the embodiments.

Referring to FIG. 8, for 10 seconds after driving, temperature of the prior art heating roller is about 204 degrees Celsius and temperature of the heating roller according to the embodiments is about 220 degrees Celsius. From these, it may be understood that temperature-increase characteristics of the heating roller according to the embodiments is improved by about 10% in comparison to the prior art heating roller.

An image forming apparatus 1 according to an exemplary embodiment will be described with reference to FIG. 9. FIG. 9 is a schematic view illustrating an image forming apparatus 1 according to an exemplary embodiment.

Referring to FIG. 9, the image forming apparatus 1 is depicts as a laser printer. The image forming apparatus 1 includes a main body 10 and a printing medium supply unit 20 coupled with the main body 10. The main body 10 includes a developing unit 30 having an image carrier 31, a transfer roller 40, and a developing unit 50.

With describing along a printing medium feeding path P, a printing medium picked up from the printing medium supply 20 passes between the image carrier 31 and the transfer roller 40 while a developer image is transferred, undergoes a developer fixing process in the fixing unit 50, and is discharged out of the main body 10.

The fixing unit 50 includes a pressure roller 51, a heating roller 53, and an exciting coil 55. The pressure roller 51 and the heating roller 53 are disposed to face each other and the printing medium passes therebetween. The pressure roller 51 presses the printing medium and the heating roller 53 applies heat to the printing medium.

The heating roller 53 is an induction heating roller. In order to generate induction current at the heating roller 53, the exciting coil 55 is disposed near the heating roller 53. When AC current is applied to the exciting coil 55, induction current is generated from the heating roller 53 so that Joule's heat may be generated. The heating roller 53 may be any one of the heating rollers 100, 200, and 300 according to the exemplary embodiment, another exemplary embodiment, and still another exemplary embodiment.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A heating roller provided in a fixing unit of an image forming apparatus, the heating roller comprising:
a roller body; and
an induction heating layer surrounding the roller body and generating Joule's heat by an induction current;
wherein the induction heating is made of an induction heating coil wound around the surface of the roller body and the induction heating coil is made of a nickel alloy.

2. The heating roller as claimed in claim 1, wherein the induction heating coil is made of a nickel-iron alloy.

3. The heating roller as claimed in claim 2, wherein in the nickel-steel alloy, content of nickel is 36 wt %.

4. The heating roller as claimed in claim 1, wherein the induction heating coil is coated with copper or aluminum.

5. The heating roller as claimed in claim 1, wherein the heating roller includes a coil insertion recess that is disposed along a path in which the induction heating coil is wound around the roller body, and at least a part of the induction heating coil is inserted into the coil insertion recess.

6. The heating roller as claimed in claim 1, wherein a portion of the induction heating coil that is wound around a region of the heating roller having relatively high temperature-increase characteristics has a relatively lower winding density than the winding density of the heating coil around a region of the heating roller having relatively low temperature-increase characteristics.

7. The heating roller as claimed in claim 1, wherein a portion of the induction heating coil that is wound around a region of the heating roller having relatively high temperature-increase characteristics is wound by a relatively smaller number of layers than the number of layers wound around a region of the heating roller having relatively low temperature-increase characteristics.

8. The heating roller as claimed in claim 1, wherein a portion of the induction heating coil that is wound around a region of the heating roller having relatively high temperature-increase characteristics has a relatively lower magnetic permeability than the magnetic permeability a portion of the induction heating coil that is wound around a region of the heating roller having relatively low temperature-increase characteristics.

9. The heating roller as claimed in claim 1, further comprising:
a first elastic layer disposed between the roller body and the induction heating coil; and
an adhesive layer disposed on the first elastic layer for bonding of the induction heating coil.

10. The heating roller as claimed in claim 9, further comprising:
a second elastic layer disposed on the induction heating layer; and
a release layer disposed on the second elastic layer to prevent a printing medium from sticking to the heating roller.

11. The heating roller as claimed in claim 10, wherein the release layer surrounds the second elastic layer, and
the release layer is made of polytetrafluoroethylene (PTEE) or perfluoroalkoxy (PFA).

12. The heating roller as claimed in claim 1, wherein the roller body is made of ceramic.

13. The heating roller as claimed in claim 1, wherein the roller body is made of aluminum.

14. The heating roller as claimed in claim 13, further comprising an insulating layer disposed between the roller body and the induction heating coil.

15. The heating roller as claimed in claim 13, wherein the roller body is a hollow cylinder.

16. A fixing unit provided in an image forming apparatus to fix developer on a printing medium, the fixing unit comprising:
a pressure roller pressing the printing medium;
a heating roller facing the pressure roller; and
an exciting coil disposed near the heating roller to induce current at an induction heating coil of the heating roller,
wherein the heating roller comprises
a roller body; and
an induction heating layer surrounding the roller body to generate Joule's heat by an induction current,
wherein the induction heating layer is made of an induction heating coil wound around the surface of the roller body and the induction heating coil is made of a nickel alloy.

17. An image forming apparatus comprising:
a fixing unit to fix developer on a printing medium,
wherein the fixing unit comprises
a pressure roller pressing the printing medium;
a heating roller facing the pressure roller; and
an exciting coil disposed near the heating roller to induce current at an induction heating coil of the heating roller,
wherein the heating roller comprises
a roller body; and
an induction heating layer surrounding the roller body to generate Joule's heat by an induction current,
wherein the induction heating layer is made of an induction heating coil wound around the surface of the roller body and the induction heating coil is made of a nickel alloy.
